(19) United States
(12) Patent Application Publication
(10) Pub. No.: US 2021/0337289 A1
(43) Pub. Date: Oct. 28, 2021

(54) SOUNDBAR

(71) Applicant: Shenzhen Saiyuan Electronics Co., Ltd., Shenzhen (CN)

(72) Inventors: Pinghua HUANG, Shenzhen (CN); Caihong HE, Shenzhen (CN)

(21) Appl. No.: 17/368,105

(22) Filed: Jul. 6, 2021

Related U.S. Application Data
(63) Continuation of application No. PCT/CN2020/073331, filed on Jan. 20, 2020.

(30) Foreign Application Priority Data
Jan. 23, 2019 (CN) 2019201139950

(51) Int. Cl. H04R 1/02; G06F 3/16; H04R 3/00

(52) U.S. Cl. CPC H04R 1/025; G06F 3/162; G06F 3/165; H04R 2201/028; H04R 2420/07; H04R 3/00

(57) ABSTRACT

A soundbar is disclosed. The soundbar includes a circuit board module, a loudspeaker and a sound cavity housing. The loudspeaker is installed on the sound cavity housing. The sound cavity housing includes a front housing and a rear housing. A rear lower part of the rear housing is provided with a first groove structure. The circuit board module includes a circuit board, and the circuit board includes an audio interface unit, an audio processing unit and a power amplification unit connected sequentially. An output end of the power amplification unit is connected with an input end of the loudspeaker, and the audio interface unit includes a wired audio interface circuit and/or a wireless audio interface circuit.

### CROSS REFERENCE TO RELATED APPLICATION

This application is a continuation application of International Application No. PCT/CN2020/073331, filed on Jan. 20, 2020, which further claims the benefit and priority of Chinese Patent Application No. 201920113995.0 filed on Jan. 23, 2019, the disclosure of which is incorporated by reference herein in its entirety as part of the present application.

### TECHNICAL FIELD

The present disclosure relates to the technical field of sound box equipment, and more specifically, to a soundbar.

### BACKGROUND ART

The existing monitors are getting bigger, but they have no speaker of their own, or the effect of their own speaker is not very good, or the sound quality is low or poor. As a result, most people tend to equip their their monitor with a set of sound boxes. The existing sound boxes are also large in size, usually on both sides of the monitor (one on one side). In this way, it takes up space, and there are more cables, which will be very messy, very troublesome to tidy up, and it is very inconvenient to use and install.

Therefore, the prior art needs to be improved.

### SUMMARY

In view of the shortcomings of the above-mentioned prior art, the present disclosure aims to provide a soundbar, which can solve the technical problems such as large space being occupied and large number of cables in the existing sound box equipment.

In order to solve the above technical problems, the present disclosure adopts the following technical scheme.

A soundbar includes a circuit board module, a loudspeaker and a sound cavity housing. The loudspeaker is installed on the sound cavity housing. The sound cavity housing includes a front housing and a rear housing. A rear lower part of the rear housing is provided with a first groove structure. The circuit board module includes a circuit board, and the circuit board includes an audio interface unit, an audio processing unit and a power amplification unit connected sequentially. An output end of the power amplification unit is connected with an input end of the loudspeaker, and the audio interface unit includes a wired audio interface circuit and/or a wireless audio interface circuit.

As an improvement of the disclosure, a rear upper part of the rear housing is provided with a second groove structure. The circuit board module further includes a fixed housing, and the circuit board module is arranged in the second groove structure and is adapted to the second groove structure.

As an improvement of the disclosure, a depth of the first groove structure is greater than a height of the first groove structure.

As an improvement of the disclosure, a rear part of the fixed housing is provided with interface holes, and the fixed housing of the circuit board module is L-shaped and is adapted to the second groove structure.

As an improvement of the disclosure, the second groove structure and the fixed housing are respectively provided with corresponding screw fixing columns and screw fixing holes, and the circuit board module is fixed in the second groove structure by screws.

As an improvement of the disclosure, the circuit board module further includes a shielding sheet. The rear part of the fixed housing is provided with a first sinking platform. The screw fixing holes are arranged in the first sinking platform, the interface holes of the fixed housing are arranged in the first sinking platform, and the shielding sheet is pasted on an outside of the first sinking platform.

As a further improvement of the disclosure, the second groove structure is provided with a positioning step, and the positioning step and the fixed housing are respectively provided with corresponding positioning holes and positioning columns.

As a further improvement of the disclosure, the sound box further includes loudspeaker mounting screws. The loudspeaker is provided with mounting holes, and the loudspeaker mounting screws pass through the front housing and the mounting holes of the loudspeaker to fix the front housing and the loudspeaker on the rear housing together.

As a further improvement of the disclosure, a front side of the front housing is provided with a second sinking platform, and the loudspeaker is installed on the second sinking platform from front to rear.

As a further improvement of the disclosure, an angle between a front surface and a bottom surface of the sound cavity housing is less than 90 degrees.

Compared with the prior art, the provided soundbar includes a circuit board module, a loudspeaker and a sound cavity housing. The loudspeaker is installed on the sound cavity housing. The sound cavity housing includes a front housing and a rear housing. A rear lower part of the rear housing is provided with a first groove structure. The circuit board module includes a circuit board, and the circuit board includes an audio interface unit, an audio processing unit and a power amplification unit connected sequentially. An output end of the power amplification unit is connected with an input end of the loudspeaker, and the audio interface unit includes a wired audio interface circuit and/or a wireless audio interface circuit. It adopts the design of a soundbar. By setting a groove structure, it can be placed under the monitors. It has a small shape and saves space. It achieves the effect of making the sound box invisible and reduces the installation requirements of the sound box. Moreover, its wiring structure is simple. It can also be connected with mobile phones or computers through wireless connection, which is convenient to use.

### BRIEF DESCRIPTION OF THE DRAWINGS

FIG. 1 is the structural diagram of the first angle of the soundbar provided by the disclosure.

FIG. 2 is the structural diagram of the second angle of the soundbar provided by the disclosure.

FIG. 3 is the structural diagram of the fixed housing of the circuit board module of the soundbar provided by the disclosure.

FIG. 4 is the structural diagram of three embodiments A, B and C of the first groove structure of the soundbar provided by the disclosure.

FIG. 5 is the structure diagram of the soundbar without the circuit board module provided by the disclosure.

FIG. 6 is the structure diagram of the fixed housing with the shielding sheet of the circuit board module of the soundbar provided by the disclosure.

FIG. 7 is the structure diagram of the fixed housing without the shielding sheet of the circuit board module of the soundbar provided by the disclosure.

FIG. 8 is the flow chart of the working principle of the circuit board module of the soundbar provided by the disclosure.

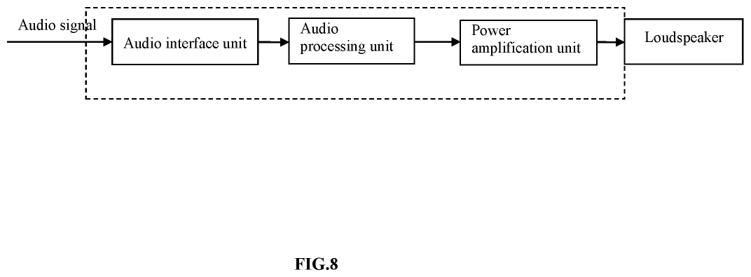

### DETAILED DESCRIPTION OF THE EMBODIMENTS

In order to make the purpose, technical scheme and advantages of the disclosure clearer, the disclosure is further described in detail in combination with the attached drawings and the embodiments below. It should be understood that the specific embodiments described herein are used only to explain the disclosure and are not used to limit the disclosure.

It should be noted that when a part is called “installed”, “fixed” or “set” on another part, it can be directly on another part or there may be a middle part at the same time. When a part is said to be “connected” with another part, it can be directly connected to another part or there may be a middle part at the same time.

It should also be noted that the expressions of left, right, upper and lower in the embodiments of the disclosure are only relative concepts to each other or refer to the normal use state of the product, and should not be regarded as restrictive.

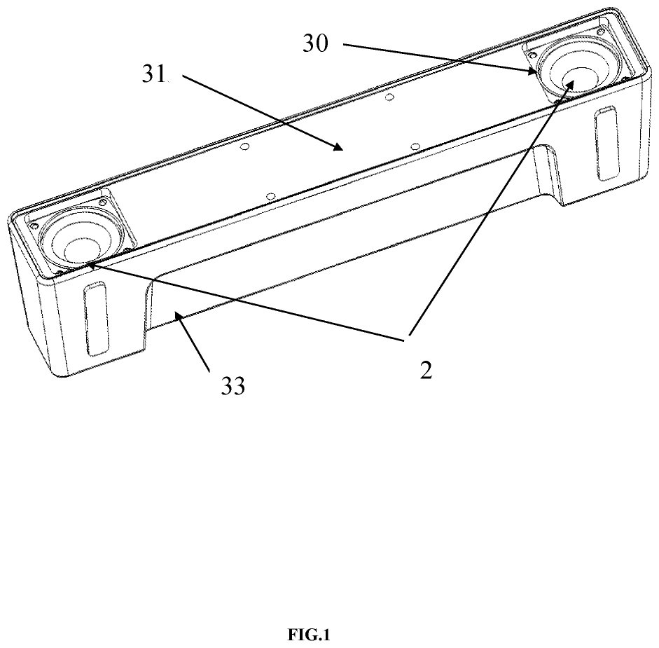

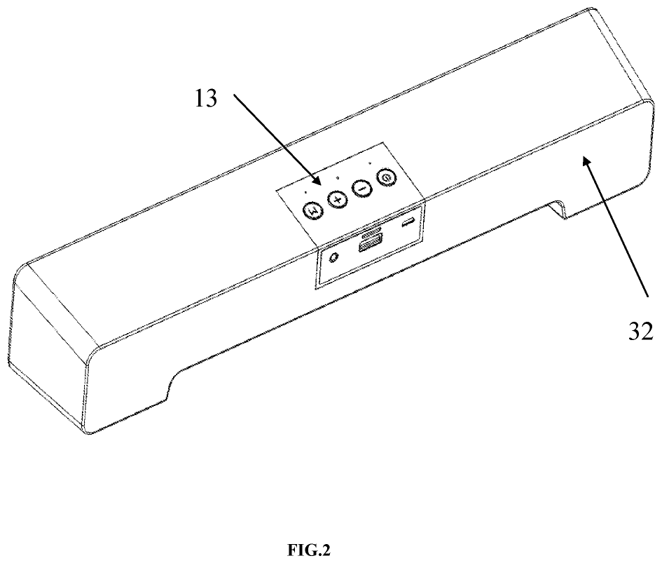

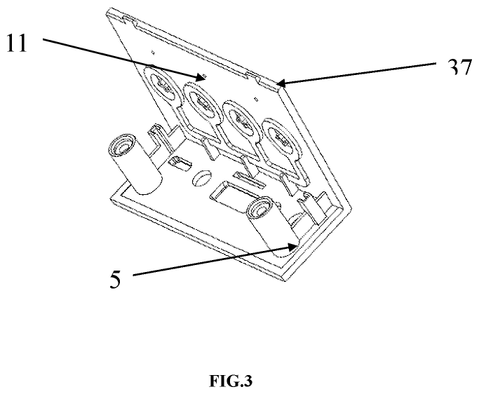

Referring to FIG. 1, FIG. 2 and FIG. 3, a preferred embodiment of the disclosure provides a soundbar. The soundbar includes a circuit board module (not shown in the figures), a loudspeaker 2 and a sound cavity housing. The loudspeaker 2 is installed on the sound cavity housing. The sound cavity housing includes a front housing 31 and a rear housing 32. A rear lower part of the rear housing 32 is provided with a first groove structure 33. The circuit board module includes a circuit board, and the circuit board includes an audio interface unit, an audio processing unit and a power amplification unit connected sequentially. An output end of the power amplification unit is connected with an input end of the loudspeaker.

In the embodiment, the circuit board module and the loudspeaker 2 are integrated and arranged on the sound cavity housing, which simplifies the installation structure. When the sound box is working, the circuit board module receives the audio signal transmitted from the external device. First, the audio signal is received by the audio interface unit, then the audio signal is converted by the audio processing unit, and then the converted audio signal is amplified by the power amplification unit, and then the loudspeaker is driven to make sound, and the audio is played.

Further, referring to FIG. 1-FIG. 5, for the soundbar provided by the disclosure, a rear upper part of the rear housing 32 is provided with a second groove structure 34. The circuit board module further includes a fixed housing 11, and the circuit board module is arranged in the second groove structure and is adapted to the second groove structure.

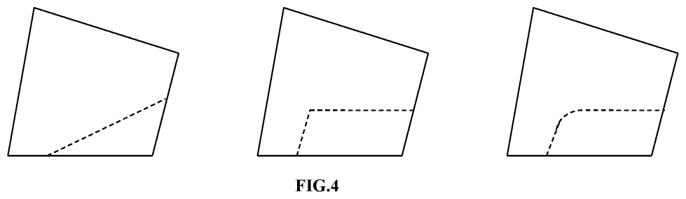

Specifically, the cross section of the first groove structure 33 can be a triangle or a polygon. In FIG. 4, A is the structure with the triangular cross section, B is the structure with the quadrilateral cross section, and C is the structure with the cross section of quadrilateral with chamfers. Moreover, the first groove structure 33 can only be seen behind the sound box, but not from the front of the sound box, so it will not affect the beauty of the product. The second groove structure 34 is arranged in an L-shape, which is convenient for installation.

Further, a depth of the first groove structure is greater than a height of the first groove structure. Because the base of the monitor is flat, this design can hide the soundbar under the monitor to the maximum extent, which simplifies the structure and saves the space, so as to achieve the effect of making the sound box invisible.

Further, a rear part of the fixed housing is provided with interface holes, and the audio interface unit includes a wireless audio interface circuit. The wireless audio interface circuit adopts a Bluetooth chip for wireless connection communication with a mobile phone or a computer. The circuit board module is arranged in the second groove structure 34. The fixed housing 13 of the circuit board module is L-shaped and is adapted to the second groove structure 34.

Specifically, the Bluetooth chip used in the wireless audio interface circuit is preferred to Bluetooth 4.2 or 5.0, which is the most mature and stable technology at present. The use of AC69 series (such as AC6925A) Bluetooth chip ensures fast transmission and lower power consumption, ensures the stability and diversity of transmission connection, and saves the trouble of wiring. The second groove structure 34 is arranged in the middle of the sound cavity housing 3 to accommodate the circuit board module. The fixed housing 13 of the circuit board module is fixed in the second groove structure 34 by screws. The fixed housing 13 is also provided with control buttons 131. The control buttons 131 include a switch button for controlling the switch of the sound box, a volume adjusting button for adjusting the volume, and a pause playing button. The operation is simple and the control is more convenient and quicker.

Further, referring to FIG. 3, the second groove structure 34 and the fixed housing 13 are respectively provided with corresponding screw fixing columns 4 and screw fixing holes 5, and the circuit board module is fixed in the second groove structure 34 by screws. The fixing is more convenient and faster, the installation is firmer, and it is not easy to fall and be damaged.

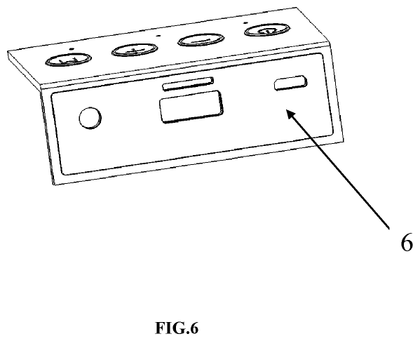

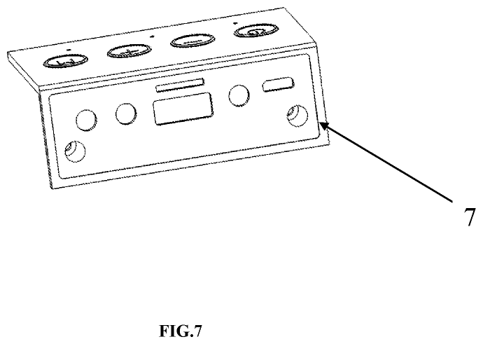

Further, referring to FIG. 3, FIG. 6 and FIG. 7, the circuit board module includes a shielding sheet 6. The rear part of the fixed housing 13 is provided with a first sinking platform (not labeled in the figures). The screw fixing holes 5 are arranged in the first sinking platform, the interface holes 7 of the fixed housing are arranged in the first sinking platform, and the shielding sheet 6 is pasted on an outside of the first sinking platform.

Specifically, the screw fixing holes 5 are arranged in the first sinking platform to facilitate disassembly and assembly. The interface holes 7 of the fixed housing are also arranged in the first sinking platform, which is convenient for fixing during connection and installation. The shielding sheet 6 is pasted on the outside of the sink platform, and this design can block the screw fixing holes 5, or the interface holes 7 of the fixed housing and the unused interface holes, making the appearance neater and more beautiful.

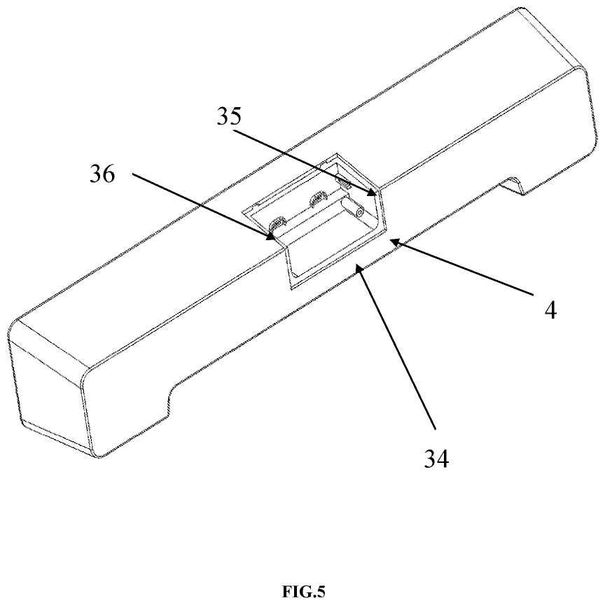

In a further embodiment, referring to FIG. 3 and FIG. 5, the second groove structure 34 is provided with a positioning step 35, and the positioning step 35 and the fixed housing 13 are respectively provided with corresponding positioning holes 36 and positioning columns 37. The setting of the positioning step 35, positioning holes 36 and positioning columns 37 is more conducive to the positioning during installation, which facilitates the installation steps and simplifies the installation process.

Further, the sound box further includes loudspeaker mounting screws. The loudspeaker 2 is provided with mounting holes, and the loudspeaker mounting screws pass through the front housing 31 and the mounting holes of the loudspeaker 2 to fix the front housing 31 and the loudspeaker 2 on the rear housing 32 together, which makes the installation of the loudspeaker more stable, firmer and not easy to fall off.

Further, a front side of the front housing 31 is provided with a second sinking platform 30, and the loudspeaker 2 is installed on the second sinking platform 30 from front to rear. By setting the second sinking platform 30 for supporting and fixing the loudspeaker 2, the loudspeaker 2 can be firmly installed on the front housing 31.

In summary, the soundbar provided by the disclosure includes a circuit board module, a loudspeaker and a sound cavity housing. The loudspeaker is installed on the sound cavity housing. The sound cavity housing includes a front housing and a rear housing. A rear lower part of the rear housing is provided with a first groove structure. The circuit board module includes a circuit board, and the circuit board includes an audio interface unit, an audio processing unit and a power amplification unit connected sequentially. An output end of the power amplification unit is connected with an input end of the loudspeaker, and the audio interface unit includes a wired audio interface circuit and/or a wireless audio interface circuit. It adopts the design of a soundbar. By setting a groove structure, it can be placed under the monitors. It has a small shape and saves space. It achieves the effect of making the sound box invisible and reduces the installation requirements of the sound box. Moreover, its wiring structure is simple. It can also achieve wireless connection, which is convenient to use.

The soundbar provided by the disclosure also has the characteristics of simple structure, convenient installation, long service life, stable and reliable use, etc.

It should be understood that for ordinary technical personnel in the art, equivalent replacements or changes can be made according to the technical scheme of the disclosure and its model concept, and all these replacements or changes shall belong to the protection scope of the claims attached to the disclosure.

What is claimed is:

1. A soundbar, comprising a circuit board module, a loudspeaker and a sound cavity housing, wherein the loudspeaker is installed on the sound cavity housing, the sound cavity housing comprises a front housing and a rear housing, a rear lower part of the rear housing is provided with a first groove structure, the circuit board module comprises a circuit board, the circuit board comprises an audio interface unit, an audio processing unit and a power amplification unit connected sequentially, an output end of the power amplification unit is connected with an input end of the loudspeaker, and the audio interface unit comprises a wired audio interface circuit and/or a wireless audio interface circuit.

2. The soundbar of claim 1, wherein a rear upper part of the rear housing is provided with a second groove structure, the circuit board module further comprises a fixed housing, and the circuit board module is arranged in the second groove structure and is adapted to the second groove structure.

3. The soundbar of claim 1, wherein a depth of the first groove structure is greater than a height of the first groove structure.

4. The soundbar of claim 2, wherein a rear part of the fixed housing is provided with interface holes, and the fixed housing of the circuit board module is L-shaped and is adapted to the second groove structure.

5. The soundbar of claim 2, wherein the second groove structure and the fixed housing are respectively provided with corresponding screw fixing columns and screw fixing holes, and the circuit board module is fixed in the second groove structure by screws.

6. The soundbar of claim 5, wherein the circuit board module further comprises a shielding sheet, the rear part of the fixed housing is provided with a first sinking platform, the screw fixing holes are arranged in the first sinking platform, the interface holes of the fixed housing are arranged in the first sinking platform, and the shielding sheet is pasted on an outside of the first sinking platform.

7. The soundbar of claim 2, wherein the second groove structure is provided with a positioning step, and the positioning step and the fixed housing are respectively provided with corresponding positioning holes and positioning columns.

8. The soundbar of claim 1, further comprising loudspeaker mounting screws, wherein the loudspeaker is provided with mounting holes, and the loudspeaker mounting screws pass through the front housing and the mounting holes of the loudspeaker to fix the front housing and the loudspeaker on the rear housing together.

9. The soundbar of claim 1, wherein a front side of the front housing is provided with a second sinking platform, and the loudspeaker is installed on the second sinking platform from front to rear.

10. The soundbar of claim 1, wherein an angle between a front surface and a bottom surface of the sound cavity housing is less than 90 degrees.
